(19) United States
(12) Patent Application Publication
(10) Pub. No.: US 2013/0345609 A1
(43) Pub. Date: Dec. 26, 2013

(54) Lavatory Massaging Foot Stool

(71) Applicant: Anna L. MILLER, Manning, SC (US)

(72) Inventor: Anna L. MILLER, Manning, SC (US)

(21) Appl. No.: 13/529,215

(22) Filed: Jun. 21, 2012

(51) Int. Cl. A61H 15/00

(52) U.S. Cl. 601/120

(57) ABSTRACT

The present invention is a lavatory massaging foot stool which allows the user to perform bowel movements with more ease and to allow the feet of the user to be massaged during the process. The lavatory massaging foot stool has a base, a pair of supports and an at least one rolling pin. In an alternative preferred embodiment, the base is made a series of planks that have been affixed adjacent to each other. A first rolling pin support and a second rolling pin support allow the at least rolling pin to be rotatably connected to the base of the present invention. The connection of the at least one rolling pin to the base via the first rolling pin support and the second rolling pin support allows the at least one rolling pin to be freely rotatable and elevated above the base and consequently the ground.

### FIELD OF THE INVENTION

The present invention relates generally to a lavatory massaging foot stool which allows the user to perform bowel movements with more ease and to allow the feet of the user to be massaged during the process.

### BACKGROUND OF THE INVENTION

Two thirds of the world population uses the squatting position to perform bowel movements. In cultures wherein the squatting position is practiced, diseases such as appendicitis, diverticulitis, hemorrhoids, colitis, prostate disorders and colon cancer are virtually unknown. Therefore, the squatting position has been widely recommended by doctors and yoga teachers for easier and more complete elimination. The present invention is a footstool that enables a person using the toilet to easily achieve the natural squatting position for bowel movements. In a natural squatting position, the knee joints are above the hip joint. It has been found that elevated knees help align the large intestine and the anus. Therefore, relieving the bowel is made easier. The present invention not only allows the knees of the user to be elevated, but also allows the feet of the user to be properly massaged to stimulate blood flow therein. It has been found that keeping the blood flow stimulated in the feet is beneficial in keeping the organs of the body healthy. Furthermore, the present invention eliminates the need for the user to perch on the rim of the toilet in executing the squatting position.

### BRIEF DESCRIPTION OF THE DRAWINGS

FIG. 1 is a perspective view of a preferred embodiment of the present invention.

FIG. 2 is another perspective view of the preferred embodiment of the present invention.

FIG. 3 is a front view of the preferred embodiment of the present invention.

FIG. 4 is lateral view of the preferred embodiment of the present invention.

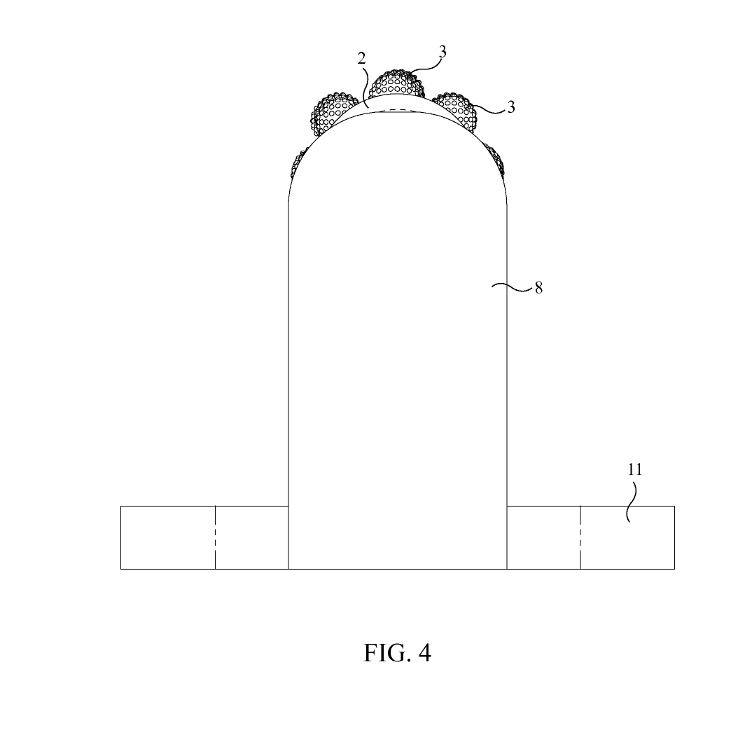

FIG. 5 is a top view of the preferred embodiment of the present invention.

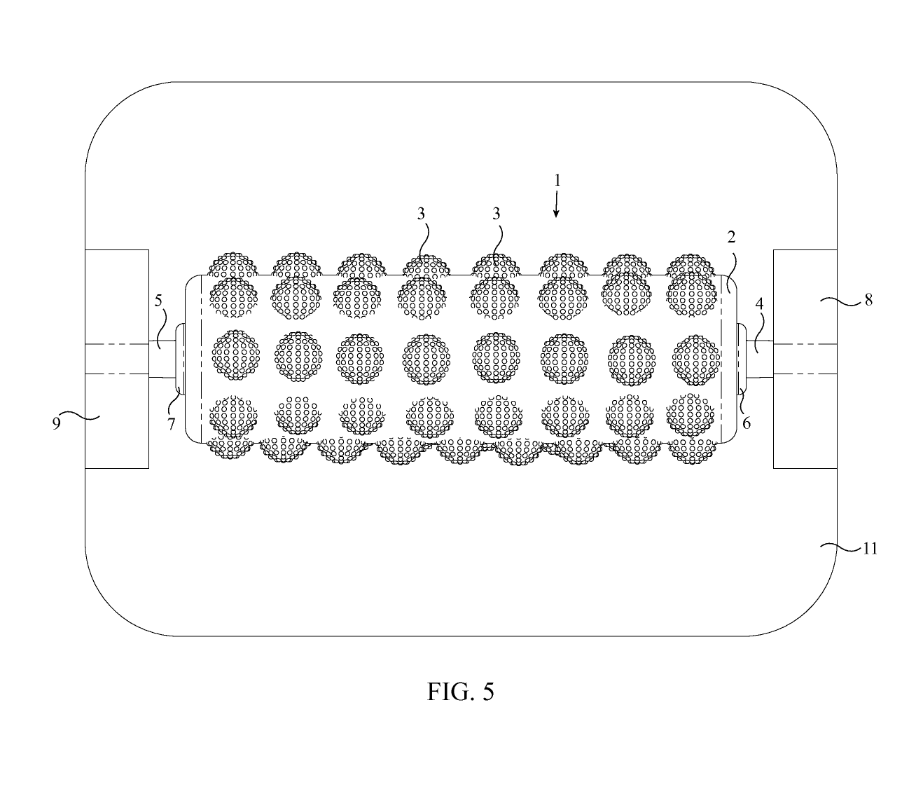

FIG. 6 is a bottom view of the preferred embodiment of the present invention.

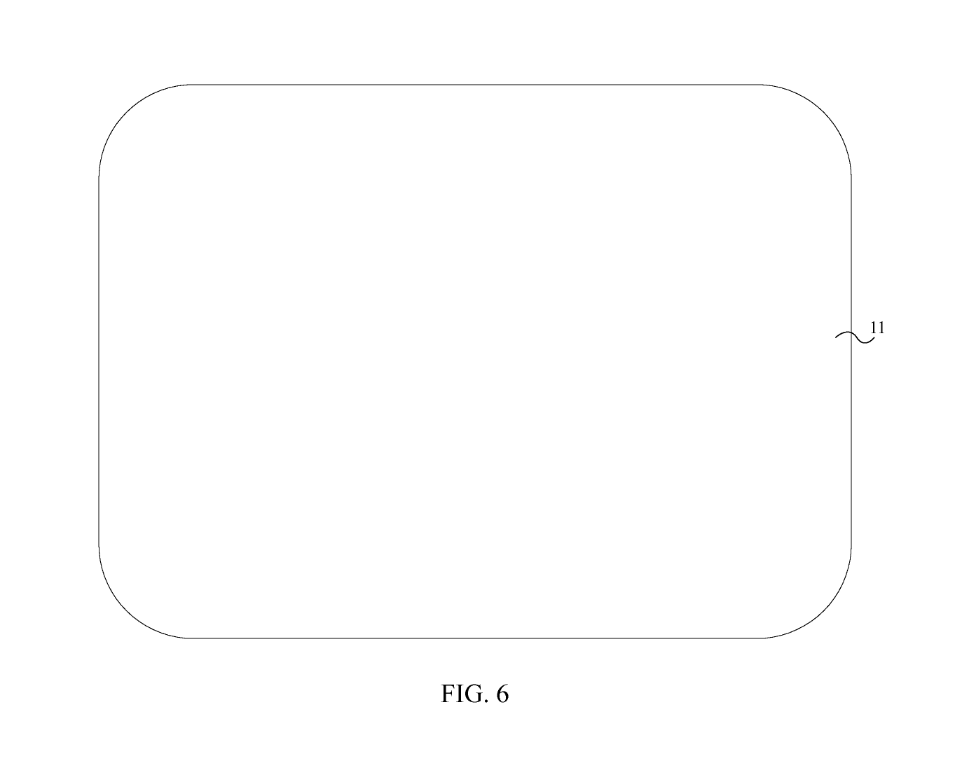

### DETAILED DESCRIPTION OF THE INVENTION

All illustrations of the drawings are for the purpose of describing selected versions of the present invention and are not intended to limit the scope of the present invention.

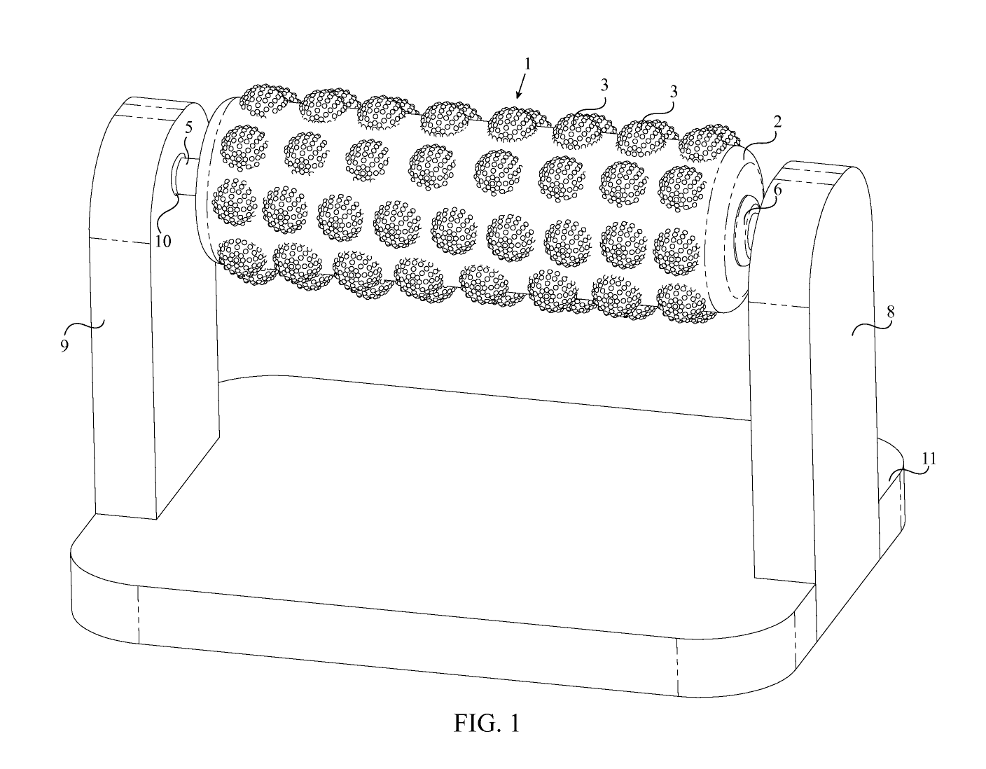

The present invention is a lavatory massaging foot stool used to help facilitate bowel movements of a user and to provide comfort to the feet of the user. As shown in FIG. 1, the lavatory massaging foot stool comprises an at least one rolling pin 1, a first rolling pin support 8, a second rolling pin support 9, and a base 11. The first rolling pin support 8, the second rolling pin support 9, and the base 11 can be continuously connected and manufactured from one piece of material. In the preferred embodiment, the base 11 is a singular plank attached to the first rolling pin support 8 and the second rolling pin support 9. In an alternative preferred embodiment, the base 11 comprises a first plank, a second plank and a third plank. The first rolling pin support 8 and the second rolling pin support 9 are rectangular support members which the at least one rolling pin 1 is attached thereto. The first rolling pin support 8 and the second rolling pin support 9 are positioned opposite to each other along the base 11 of the present invention. In the alternative preferred embodiment, the first rolling pin support 8 and the second rolling pin support 9 are positioned opposite to each other along the length of the third plank. Moreover, the first rolling pin support 8 and the second rolling pin support 9 are positioned at opposite ends of the base 11 or the third plank. Furthermore, the first rolling pin support 8 and the second rolling pin support 9 are positioned normal to the base 11. Both of the first rolling pin support and the second rolling pin support each comprises a pin hole 10. The pin hole 10 of the first rolling pin support 8 and the pin hole of the second rolling pin support 9 are positioned on the support thereof and opposite to the base 11. Consequently, the first rolling pin support 8 and the second rolling pin support 9 are rectangular blocks that are perpendicularly affixed at opposite ends of the base 11 or the third plank. In the preferred embodiment, the length of both the first rolling pin support 8 and the second rolling pin support 9 is eighteen inches.

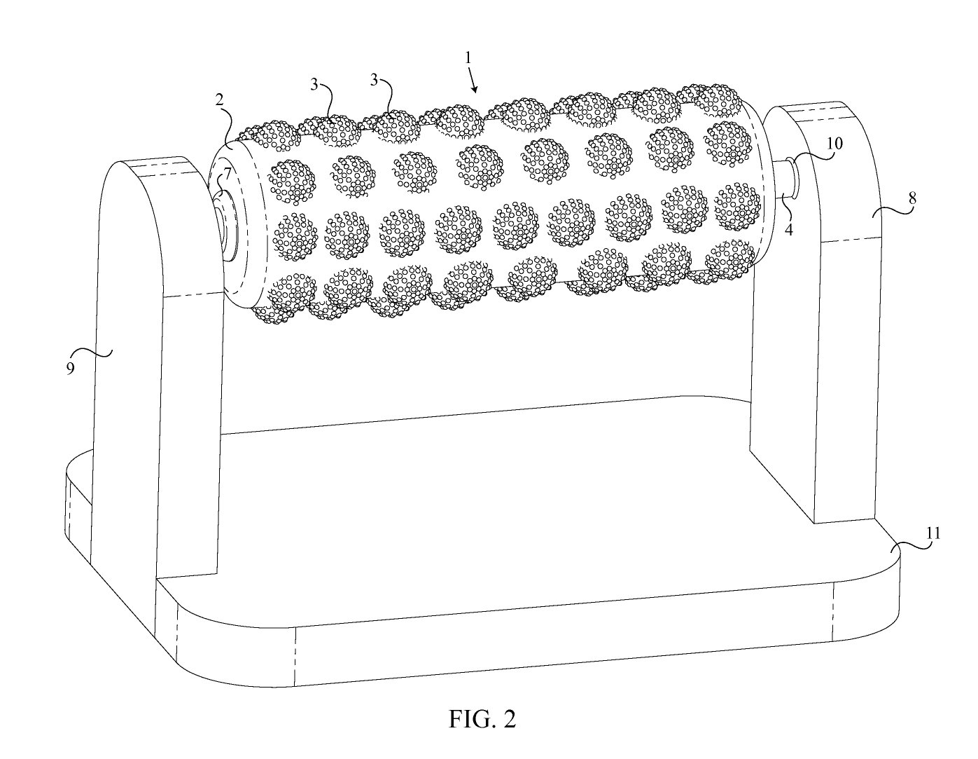

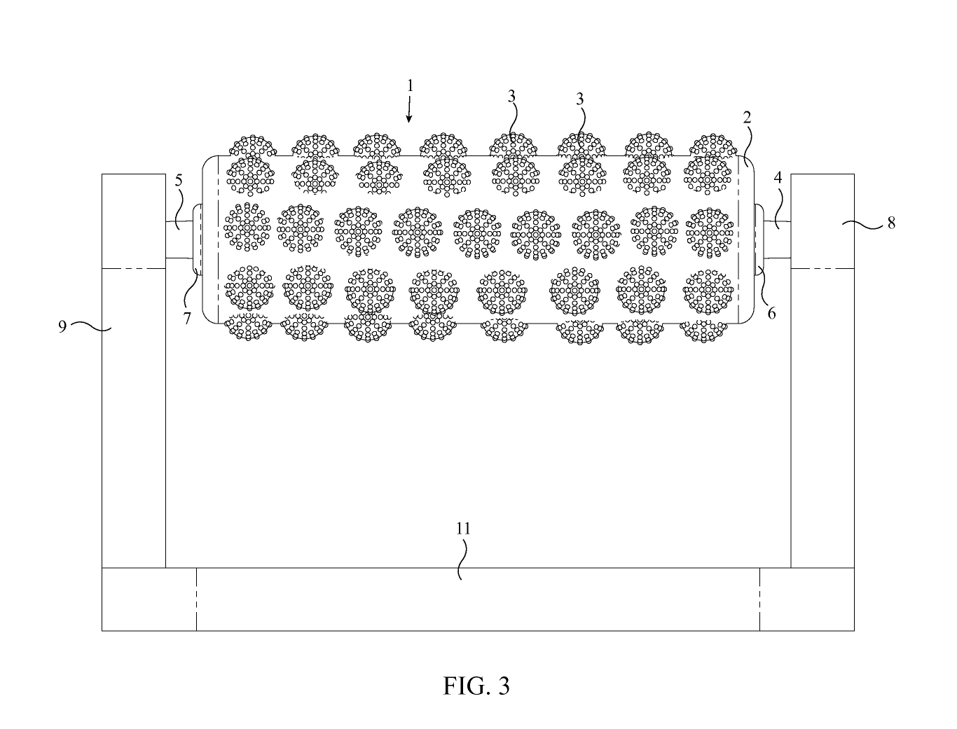

In the preferred embodiment, the affixation of the first rolling pin support 8 and the second rolling pin support 9 to the base 11 allows the at least one rolling pin to be rotatably connected in between the first rolling pin support 8 and the second rolling pin support 9. As illustrated in FIG. 3, the at least one rolling pin 1 is connected to the first rolling pin support 8 via the first pin handle 4, and the at least one rolling pin 1 is connected to the second rolling pin support 9 via the second pin handle 5. As illustrated in FIG. 1 and FIG. 2, the first pin handle 4 traverses through the first rolling pin support 8 via the pin hole 10. The second pin handle 5 traverses through the second rolling pin support 9 via the pin hole 10. Specifically, the at least one rolling pin 1 is elevated above the base 11 in accordance with the height of the first rolling pin support 8 and the second rolling pin support 9. The height of both the first rolling pin support 8 and the second rolling pin support 9 is arbitrary and may be constructed to be any desired height. In the alternative preferred embodiment, the affixation of the first rolling pin support 8 and the second rolling pin support 9 to the opposite ends of the third plank is facilitated by the attachment of a plurality of support fasteners. The plurality of support fasteners maintains the first rolling pin support 8 and the second rolling pin support 9 affixed to both ends of the third plank. Moreover, the plurality of support fasteners help stabilize both the first rolling pin support 8 and the second rolling pin support 9 as well as the overall structure of the present invention. Thus, the first rolling pin support 8 and the second rolling pin support 9 elevate the at least one rolling pin 1 above the base or the third plank. With the at least one rolling pin 1 elevated above the ground, the user may place his or her feet thereon. Furthermore, the elevated position of the at least one rolling pin 1 helps align the body of the user for ease of elimination of feces from the bowel. The at least one rolling pin 1 is connected atop and perpendicularly to both the first rolling pin support 8 and the second rolling pin support 9. In the preferred embodiment, the present invention comprises only one rolling pin 1, but it is understood that there are other variations wherein more than one rolling pin may be comprised. In another embodiment comprising more than one rolling pin, the rolling pins are smaller compared to the at least one rolling pin 1 in the present preferred embodiment. Furthermore, in the preferred embodiment the at least one rolling pin 1 is composed of wood, preferably oak. The full length of the at least one rolling pin 1 in the preferred embodiment is eighteen inches. The at least one rolling pin 1 is attached in a manner wherein a first pin handle 4 is rotatably connected to the first rolling pin support 8 and a second pin handle 5 is rotatably connected to the second rolling pin support 9.

In the alternative preferred embodiment, the first pin handle 4 is rotatably connected to the first rolling pin support 8 via a first rolling pin fastener, and the second pin handle 5 is rotatably connected to the second rolling pin support 9 via a second rolling pin fastener. The first rolling pin fastener and the second rolling pin fastener are connection mechanisms that connect the at least one rolling pin 1 to the first rolling pin support 8 and the second rolling pin support 9. Specifically, the first rolling pin fastener connects the first pin handle 4 to the first rolling pin support 8, and the second rolling pin fastener connects the second pin handle 5 to the second rolling pin support 9. In the alternative preferred embodiment, the first rolling pin fastener and the second rolling pin fastener are two circular connection pins wherein the first pin handle 4 and the second pin handle 5 traverse therethrough. Moreover, the first rolling pin fastener and the second rolling pin fastener allow the at least one rolling pin 1 to rotate freely about the vertical axis thereof. Since the at least one rolling pin 1 is free to rotate about the vertical axis thereof, the at least one rolling pin 1 allows the user to massage the bottom of his or her feet upon and around the circumferentially lateral surface of a cylindrical body 2 of the at least one rolling pin 1. The at least one rolling pin 1 is free to rotate about the vertical axis thereof in both preferred embodiments. In massaging the soles of his or her feet upon the at least one rolling pin 1, the user rolls and rotates the at least one rolling pin 1 up and down about the vertical axis thereof. The vertical axis of the at least one rolling pin 1 is perpendicularly positioned upon both the first rolling pin support 8 and the second rolling pin support 9. Furthermore, the vertical axis of the at least one rolling pin 1 or the length of the at least one rolling pin 1 is parallel to the third plank or the base 11 located beneath thereof.

As illustrated in FIG. 3, the cylindrical body 2, the first pin handle 4, the second pin handle 5, the first rolling pin ring 6 and the second rolling pin ring 7 are all positioned collinearly to each other in the both preferred embodiments. The first pin handle 4 is attached to the cylindrical body 2 of the at least one rolling pin 1 via a first rolling pin ring 6, and the second pin handle 5 is attached to the cylindrical body 2 of the at least one rolling pin 1 via a second rolling pin ring 7. Specifically, the first rolling pin ring 6 and the second rolling pin ring 7 are positioned opposite to each other along the length of the cylindrical body 2. Furthermore, the first rolling pin ring 6 and the second rolling pin ring 7 are positioned at opposite ends of the cylindrical body 2. Due to the affixation of the first pin handle 4 to the first rolling pin ring 6 and the second pin handle 5 to the second rolling pin ring 7, the first pin handle 4 and the second pin handle 5 are consequently positioned opposite to each other at both ends of the cylindrical body 2. The cylindrical body 2 is encircled laterally by a plurality of protrusions 3. In some embodiments, the cylindrical body 2 may be smooth and free of the plurality of protrusions 3. In the preferred embodiment, each of the plurality of protrusions 3 is a small circular body which raises and protrudes out and off from the lateral surface of the cylindrical body 2 thereof. One variation for each of the plurality of the protrusions includes each of the plurality of the protrusions comprising a plurality of smaller protrusions that also raises above and protrudes out from the top surface of each of the plurality of protrusions 3 thereof. In some embodiments, the plurality of protrusions 3 may be smooth and free of smaller protrusions. The plurality of protrusions 3 may be constructed to be any desired size, and any number of protrusions may be constructed onto the rolling pin 1.

The plurality of protrusions 3 serve as massaging protrusions which help stimulate blood flow in the feet of the user. Furthermore, the plurality of protrusions 3 assists in keeping the organs of the body in good health. The at least one rolling pin 1 mimics the action or results of reflexology. According to Dr. Oz, it is a medical fact that the elevation of the knees provides more relief and ease to the user during the defecation process. The extra ease that the user experiences is due to the elevated position of the knees, which help align the large intestines and anus during the process. The present invention is especially helpful for the elderly with digestive and bowel problems.

In the alternative preferred embodiment, the stability of the third plank of the present invention is reinforced by the lateral affixation of the first plank and the second plank thereto. Specifically, the third plank is affixed in between the first plank and the second plank. Furthermore, the first plank and the second plank are affixed at opposite lateral sides of the third plank via a plurality of plank fasteners. The plurality of plank fasteners is situated along an abutment between the first plank and the third plank, and an abutment between the second plank and the third plank. The lateral adjunction of the first plank to the third plank, and the third plank to the second plank gives the present invention a broader base as well as a stable base. With a large stable base, the weight of the feet of the user may be evenly supported without the overall structure of the present invention becoming unstable. Furthermore, the overall weight of the feet helps the base of the present invention from moving laterally out of place on the floor. In the alternative preferred embodiment, the base, which comprises the first plank, the second plank and the third plank altogether, is eleven inches wide, fifteen inches long, and six inches high. In the preferred embodiment, the base 11 is also made of similar aforementioned dimensions. The alternative preferred embodiment, the present invention is made with five pieces wherein each piece comprises a two-inch width and a four-inch length, and a rolling pin. Therefore, the present invention is entirely portable. The prototype of the present invention has a base of sixteen inches by ten and a half inches. The present invention is also made to match the decor of the bathroom. Furthermore, both of the preferred embodiments of the present invention are made of wood.

Although the invention has been explained in relation to its preferred embodiment, it is to be understood that many other possible modifications and variations can be made without departing from the spirit and scope of the invention as hereinafter claimed.

What is claimed is:

1. A lavatory massaging foot stool comprises:
an at least one rolling pin;
a first rolling pin support;
a second rolling pin support;
a base;
the first rolling pin support and the second rolling pin support each comprises a pin hole; and
the at least one rolling pin comprises a cylindrical body, a plurality of protrusions, a first pin handle, a second pin handle, a first rolling pin ring, and a second rolling pin ring;
the cylindrical body, the first pin handle, the second pin handle, the first rolling pin ring and the second rolling pin ring being positioned collinearly to each other;
the first rolling pin support and the second rolling pin support being positioned opposite to each other along the base;
the first rolling pin support and the second rolling pin support being positioned normal to the base;
the pin hole of the first rolling pin support being positioned opposite to the base;
the pin hole of the second rolling pin support being positioned opposite to the base; and
the at least one rolling pin being rotatably connected in between the first rolling pin support and the second rolling pin support.

2. The lavatory massaging foot stool as claimed in claim 1 comprises,
the at least one rolling pin being rotatably connected to the first rolling pin support via the first pin handle; and
the at least one rolling pin being rotatably connected to the second rolling pin support via the second pin handle.

3. The lavatory massaging foot stool as claimed in claim 2 comprises,
the first pin handle traversing through the first rolling pin support via the pin hole; and
the second pin handle traversing through the second rolling pin support via the pin hole.

4. The lavatory massaging foot stool as claimed in claim 1 comprises,
the first rolling pin ring and the second rolling pin ring being positioned opposite to each other along the cylindrical body.

5. The lavatory massaging foot stool as claimed in claim 4 comprises,
the first pin handle being affixed adjacent to the first rolling pin ring; and
the second pin handle being affixed adjacent to the second rolling pin ring.

6. The lavatory massaging foot stool as claimed in claim 1 comprises,
the cylindrical body being laterally encircled by the plurality of protrusions.

7. A lavatory massaging foot stool comprises:
an at least one rolling pin;
a first rolling pin support;
a second rolling pin support;
a base;
the first rolling pin support and the second rolling pin support each comprises a pin hole;
the at least one rolling pin comprises a cylindrical body, a plurality of protrusions, a first pin handle, a second pin handle, a first rolling pin ring, and a second rolling pin ring;
the cylindrical body, the first pin handle, the second pin handle, the first rolling pin ring and the second rolling pin ring being positioned collinearly to each other;
the first rolling pin support and the second rolling pin support being positioned opposite to each other along the base;
the first rolling pin support and the second rolling pin support being positioned normal to the base;
the pin hole of the first rolling pin support being positioned opposite to the base;
the pin hole of the second rolling pin support being positioned opposite to the base;
the at least one rolling pin being rotatably connected in between the first rolling pin support and the second rolling pin support;
the at least one rolling pin being rotatably connected to the first rolling pin support via the first pin handle;
the at least one rolling pin being rotatably connected to the second rolling pin support via the second pin handle;
the first pin handle traversing through the first rolling pin support via the pin hole; and
the second pin handle traversing through the second rolling pin support via the pin hole.

8. The lavatory massaging foot stool as claimed in claim 7 comprises, the first rolling pin ring and the second rolling pin ring being positioned opposite to each other along the cylindrical body.

9. The lavatory massaging foot stool as claimed in claim 8 comprises,
the first pin handle being affixed adjacent to the first rolling pin ring; and
the second pin handle being affixed adjacent to the second rolling pin ring.

10. The lavatory massaging foot stool as claimed in claim 7 comprises,
the cylindrical body being laterally encircled by the plurality of protrusions.

11. A lavatory massaging foot stool comprises:
an at least one rolling pin;
a first rolling pin support;
a second rolling pin support;
a base;
the first rolling pin support and the second rolling pin support each comprises a pin hole;
the at least one rolling pin comprises a cylindrical body, a plurality of protrusions, a first pin handle, a second pin handle, a first rolling pin ring, and a second rolling pin ring;
the cylindrical body, the first pin handle, the second pin handle, the first rolling pin ring and the second rolling pin ring being positioned collinearly to each other;
the first rolling pin support and the second rolling pin support being positioned opposite to each other along the base;
the first rolling pin support and the second rolling pin support being positioned normal to the base;
the pin hole of the first rolling pin support being positioned opposite to the base;
the pin hole of the second rolling pin support being positioned opposite to the base;
the at least one rolling pin being rotatably connected in between the first rolling pin support and the second rolling pin support;
the at least one rolling pin being rotatably connected to the first rolling pin support via the first pin handle;
the at least one rolling pin being rotatably connected to the second rolling pin support via the second pin handle;
the first pin handle traversing through the first rolling pin support via the pin hole;
the second pin handle traversing through the second rolling pin support via the pin hole; and
the cylindrical body being laterally encircled by the plurality of protrusions.

12. The lavatory massaging foot stool as claimed in claim 11 comprises,
the first rolling pin ring and the second rolling pin ring being positioned opposite to each other along the cylindrical body;
the first pin handle being affixed adjacent to the first rolling pin ring; and
the second pin handle being affixed adjacent to the second rolling pin ring.
